(19) United States
(12) Patent Application Publication
(10) Pub. No.: US 2012/0111187 A1
(43) Pub. Date: May 10, 2012

(54) FLOW CONTROL NEEDLE MICRO ADJUSTMENT ASSEMBLY

(75) Inventors: GLEN A. MORR, CHURUBUSCO, IN (US); SCOTT A. SHEPHERD, HOAGLAND, IN (US); LARRY E. KEELING, JR., FORT WAYNE, IN (US)

(73) Assignee: PHD, INC., FORT WAYNE, IN (US)

(21) Appl. No.: 13/288,534

(22) Filed: Nov. 3, 2011

Related U.S. Application Data
(60) Provisional application No. 61/410,073, filed on Nov. 4, 2010.

(51) Int. Cl. F15B 15/22; F15B 11/048; F01B 31/12; F16K 47/10

(52) U.S. Cl. 92/143; 91/407; 91/420; 92/5 R

(57) ABSTRACT

A fluid cylinder actuator assembly is provided. The assembly includes a cylinder tube and a cushion control needle assembly. The cushion control needle assembly is configured to extend into the fluid cylinder actuator assembly to control fluid that exits the cylinder tube and comprises: a threaded cushion control differential screw that selectively screws into a retainer having corresponding threads; a control needle that includes a stem selectively extendable through a bore in the retainer opposite of the cushion control differential screw; wherein the stem of the control needle is engageable with a threaded bore inside the cushion control differential screw that is complimentary to the threads formed on the stem so that rotating the threaded cushion control differential screw will selectively extend or retract the control needle back and forth; and wherein threads of the threaded cushion control differential screw is different than the threads in its threaded bore.

### RELATED APPLICATIONS

The present application is related to and claims priority to U.S. Provisional Patent Application Ser. No. 61/410,073, filed on Nov. 4, 2010, entitled “Flow Control Needle Micro Adjustment Assembly.” To the extent not included below, the subject matter disclosed in that application is hereby expressly incorporated into the present application.

### TECHNICAL FIELD AND SUMMARY

This disclosure relates to fluid cylinder actuators that extend and retract structures. In particular, this disclosure describes flow mechanisms that influence the amount of air flow the cylinder releases to decelerate or cushion a piston or analogous structure as it ends its stroke. For example, such cylinders can be used to extend a rod into a polyethylene terephthalate (PET) preform used to make plastic bottles. The rod stretches the preform which is then blow molded into a bottle.

An air cushion is a volume of control released air that softens or “cushions” a moving piston inside a pneumatic cylinder as the piston ends its stroke. The air cushion prevents high pressure impact between the piston and the end of the cylinder which can damage both. It can also replace or supplement a conventional rubber stop.

When a piston inside a piston cylinder moves, air volume on one side of the piston cylinder increases while the volume on the other side decreases. The process of air cushioning involves slowly releasing air that would otherwise just escape from the piston cylinder as the air volume decreases. This creates resistance against the moving piston. To accomplish this, the exhaust passage in the cylinder is smaller than what is needed to exhaust the air at the same rate as the air entering the other side of the piston. Controlling the rate of release of air from the cylinder controls the amount of cushioning. A needle inserted into the exhaust passage influences how quickly air releases from the cylinder. More particularly, moving the needle in and out controls how much of the passageway is physically blocked. Moving the needle out means less of the needle blocks the passageway allowing a faster flow of air out of the cylinder. This translates into less cushioning force against the piston. Conversely, extending the needle into the passageway allows slower flow of air out of the cylinder. This translates into more air biasing the piston thereby providing more cushion force.

The needle is threaded so rotating it also moves it linearly to and from the passageway. It is believed that there is a small window of needle adjustment to give proper cushioning. The problem is that a small turn of an adjustment screw that is part of the needle could translate into a large change in the control effect of the needle. This effectively limits the ability to make fine or precise adjustments to the cushioning effect using the needle.

Attempts to solve this problem by using a very fine pitch thread on the needle introduce significant problems in manufacturing and assembly. This disclosure describes a system that includes a needle assembly offering more precise adjustments of the needle to achieve the “proper cushioning.” In an embodiment, the needle assembly precisely controls how much the needle blocks an air escape passageway. This is achieved by coupling an adjustment screw to the needle. This can illustratively be achieved using two unequal screw threads. One set of threads connects the adjusting screw to the cylinder structure while the other set of threads connects the adjusting screw to the needle. The difference in the two thread leads allows a large rotary adjustment to be converted into a small precise linear motion of the needle while preserving the use of robust, standard threads to ease manufacturing and assembly.

An illustrative embodiment of the present disclosure provides a fluid cylinder actuator assembly that comprises a cylinder tube, a cap, a head, a rod, a piston, a manifold assembly, a fluid transfer tube, an accumulator chamber, a fluid distribution assembly, a cushion stud, and a cushion control needle assembly. The cap is located at a first end of the cylinder tube. The head is located at a second end of the cylinder tube opposite the first end. The rod extends through the cylinder tube and the head. The piston couples to the rod inside the cylinder tube separating the cylinder tube into extend and retract sides. To that end, the rod is configured to move between extend and retract positions. The fluid transfer tube extends between the cap and the manifold assembly and is configured to distribute pneumatic fluid to the extend side of the cylinder tube. The accumulator chamber is positioned between the cap and the manifold assembly and is in fluid communication with the extend side of the cylinder. The fluid distribution assembly is attached to the cylinder actuator assembly and is configured to distribute fluid between retract and extend sides of the cylinder tube. The cushion stud extends from the piston opposite from the rod and is configured to selectively extend into a receptacle in the cap. Lastly, the cushion control needle assembly is configured to extend into an opening in the cap to control the amount of fluid that exits from the retract side of the cylinder tube.

In the above and other embodiments, the fluid cylinder actuator assembly further comprises: the cushion control needle assembly further including a threaded cushion control differential screw that selectively screws into a retainer having corresponding threads, a control needle that includes a stem that is selectively extendable through a bore formed in the retainer, wherein the stem of the control needle is engageable with a threaded bore formed inside the cushion control differential screw; the threaded bore of the threaded cushion control differential screw being engageable with complimentary threads formed on the stem so that rotating the threaded cushion control differential screw extends or retracts the control needle back and forth; the threaded surface of the threaded cushion control differential screw being different than the threads on the stem; the opening in the cap that receives the cushion control needle assembly forms a bore having surfaces that are not round; the bore having surfaces that are not round has surfaces that are hex shape and are complimentary to a nut located on the control needle to prevent the control needle from rotating as it moves back and forth in the bore of the cap to limit the amount of air that can escape the cap; the bore has at least one non-curved shape that is complimentary to a non-curved shape located on the control needle to prevent the control needle from rotating as it moves back and forth in the bore of the cap to limit the amount of air that can escape the cap; the head including a flange that is attachable to a blow mold machine; the rod further including an eyelet at its end thereof opposite its coupling to the piston; an accumulator needle extending through a second opening in the cap to control fluid that passes through a second passage in the cap that is in fluid communication with the accumulator chamber; a muffler and an orifice plug assembly that attach to the manifold; a visual pressure indicator that couples to the manifold; the cushion control differential screw being configured to rotate which translates minimal linear movement of the control needle; and about 34 turns of the cushion control differential screw being configured to move the control needle a linear distance of about 0.153 inches.

Another illustrative embodiment of the present disclosure includes a fluid cylinder actuator assembly that comprises: a cylinder tube, a cap, a head, a rod, a piston, and a cushion control needle assembly. The cap is located at a first end of the cylinder tube and the head is located at a second end of the cylinder tube opposite the first end. The rod extends through the cylinder tube and the head. The piston is coupled to the rod inside the cylinder tube separating the cylinder tube into extend and retract sides. The rod is configured to move between extend and retract positions. The cushion control needle assembly is configured to extend into an opening in the cap to control fluid that exits from the retract side of the cylinder tube, and comprises: a threaded cushion control differential screw that selectively screws into a retainer having corresponding threads; a control needle that includes a stem that is selectively extendable through a bore in the retainer opposite the cushion control differential screw; wherein the stem of the control needle is also engageable with a threaded bore inside the cushion control differential screw; wherein the threads of the threaded bore are complimentary to the threads formed on the stem so that rotating the threaded cushion control differential screw will extend or retract the control needle back and forth; and wherein the threaded surface of the threaded cushion control differential screw is different than the threads on the stem.

In the above and alternative embodiments the fluid cylinder actuator assembly may further comprise: the opening in the cap that receives the cushion control needle assembly including a bore having surfaces that are not round; the bore having surfaces that are not round has a hex shape surface complimentary to a nut located on the control needle to prevent the control needle from rotating as it moves back and forth in the bore of the cap to limit the amount of air that can escape the cap; the bore has at least one non-curved shape that is complimentary to a non-curved shape located on the control needle to prevent the control needle from rotating as it moves back and forth in the bore of the cap to limit the amount of air that can escape the cap; the head including a flange that is attachable to a blow mold machine; the rod further comprising an eyelet at its end thereof opposite its coupling to the piston; an accumulator needle that extends through a second opening in the cap to control fluid that passes through a second passage in the cap that is in fluid communication with an accumulator tube; a muffler and an orifice plug assembly that attach to a manifold; a visual pressure indicator that couples to the manifold; the cushion control differential screw being configured to rotate which translates minimal linear movement of the control needle; and about 34 turns of the cushion control differential screw being configured to move the control needle a linear distance of about 0.153 inches.

Another illustrative embodiment of the fluid cylinder actuator assembly comprises a cylinder tube and a cushion control needle assembly. The cushion control needle assembly is configured to extend into the fluid cylinder actuator assembly to control fluid that exits the cylinder tube and comprises: a threaded cushion control differential screw that selectively screws into a retainer having corresponding threads; a control needle that includes a stem selectively extendable through a bore in the retainer opposite of the cushion control differential screw; wherein the stem of the control needle is engageable with a threaded bore inside the cushion control differential screw that is complimentary to the threads formed on the stem so that rotating the threaded cushion control differential screw will selectively extend or retract the control needle back and forth; and wherein threads of the threaded cushion control differential screw is different than the threads in its threaded bore.

Additional features and advantages of the flow control micro adjustment needle assembly will become apparent to those skilled in the art upon consideration of the following detailed descriptions exemplifying the best mode of carrying out the flow control micro adjustment needle assembly as presently perceived.

### BRIEF DESCRIPTION OF THE DRAWINGS

The present disclosure will be described hereafter with reference to the attached drawings which are given as non-limiting examples only.

FIG. 1 is a perspective view of a pneumatic cylinder slide assembly;

FIG. 2 is an exploded view of the cylinder slide assembly;

FIG. 3 is an exploded view of the cap, cushion control needle assembly and accumulator needle portions of the cylinder slide assembly;

FIG. 4 is an exploded view of the cushion control needle;

FIG. 5 is a cross-sectional exploded view of the cushion control needle;

FIGS. 6a-c are side cross-sectional and detail views of the cushion control needle extended into the cap;

FIG. 7 is a partial cutaway view of the cap;

FIG. 8 is a side view of the cushion control needle;

FIG. 9 is another side view of the cushion control needle;

FIG. 10 is a diagrammatic side view of the pneumatic cylinder slide assembly;

FIG. 11 is another diagrammatic view of the slide assembly of FIG. 10;

FIG. 12 is another diagrammatic view of the slide assembly;

FIG. 13 is another diagrammatic view of the slide assembly;

FIG. 14 is another diagrammatic view of the slide assembly;

FIG. 15 is another diagrammatic view of the slide assembly;

FIG. 16 is another diagrammatic view of the slide assembly;

FIG. 17 is another diagrammatic view of the slide assembly;

FIG. 18 is another diagrammatic view of the slide assembly;

FIG. 19 is another diagrammatic view of the slide assembly; and

FIG. 20 is another diagrammatic view of the slide assembly.

Corresponding reference characters indicate corresponding parts throughout the several views. The exemplification set out herein illustrates embodiments of the flow control needle micro adjustment assembly, and such exemplification is not to be construed as limiting the scope of the cylinder slide assembly in any manner.

### DETAILED DESCRIPTION OF THE DRAWINGS

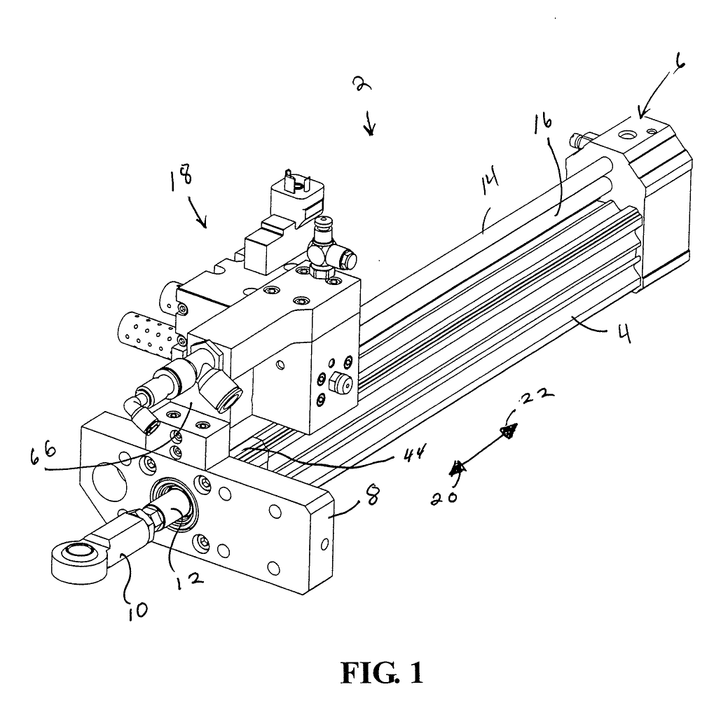

A perspective view of a pneumatic cylinder slide assembly 2 is shown in FIG. 1. Shown in this view is cylinder tube 4, bounded by cap 6 and head 44 (along with flange 8). An eye rod 10 is attached to piston rod 12. A fluid transfer tube 14 extends between cap 6 and manifold assembly 66 and is configured to distribute pneumatic fluid illustratively to the extend side (i.e., extend piston rod 12) of cylinder tube 4. An accumulator tube 16 is also positioned between cap 6 and manifold assembly 66 except that it does not assist in any fluid transfer between the two (extend or retract) sides of cylinder 4. Instead, it is in fluid communication with one side of the cylinder. For example, in this case tube 16 is in fluid communication with the cap 6 side (i.e., extend) of slide assembly 2. A fluid distribution assembly 18 is attached to assembly 2 as illustratively shown. This assembly helps distribute the fluid between cap 6 (retract) side and head 44 (extend) side of slide assembly 2. The piston rod 12 of slide assembly 2 is configured to move between an extended position in direction 20 and a retracted position in direction 22. These cylinder slides can be used as stretch rod actuator cylinders for blow molding PET bottles.

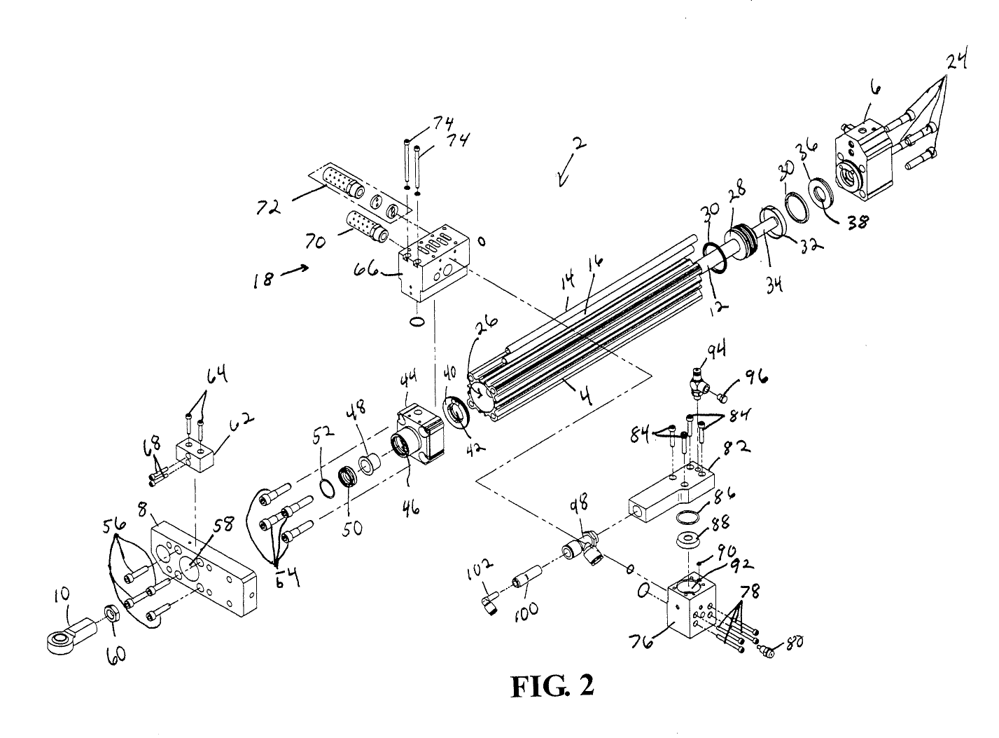

An exploded view of slide assembly 2 is shown in FIG. 2. This view shows cap 6 attaching to cylinder tube 4 via fasteners 24. A bore 26 in cylinder tube 4 receives piston rod 12, piston 28 bounded by seals 30 with wear ring 32 located around the center periphery of piston 28. A cushion stud 34 extends from the other end of the piston 28 from piston rod 12 as configured to extend in opening 38 of cavity seal 36. Fluid transfer tube 14 and accumulator tube 16 are also shown in this view. On the other side of tube 4 is a multi-function impact seal 40 with an opening 42 disposed therethrough configured to receive piston rod 12. A head 44 caps cylinder tube 4 and includes an opening 46 that also receives piston rod 12. Opening 46 also receives a bearing 48, rod seal 50 and retaining ring 52. Cap 44 is secured to cylinder tube 4 via fasteners 54. Flange 8 is attached to head 44 via fasteners 56. Eye rod 10 attaches to piston rod 12 that extends from opening 58, with the assistance of nut 60. A manifold support plate 62 attaches to flange 8 via fasteners 64. As part of fluid distribution assembly 18, manifold assembly 66 attaches to support plate 62 via fasteners 68. Muffler 70 and orifice plug assembly 72 attach to manifold 66. Fasteners 74 also attach manifold 66 to head 44. Further, inlet adaptor assembly 76 attaches to manifold 66 via fasteners 78. A visual pressure indicator 80 couples to inlet adaptor assembly 76. A cap 82 attaches to inlet adaptor assembly 76 via fasteners 84 with o-ring seal 86 and quick exhaust seal 88 and o-ring seals 90 over opening 92, 2-way push-button valve 94 and breather vent 96 attach to cap 82 as does male run tee 98. Reducer 100 and elbow 102 attach to tee 98.

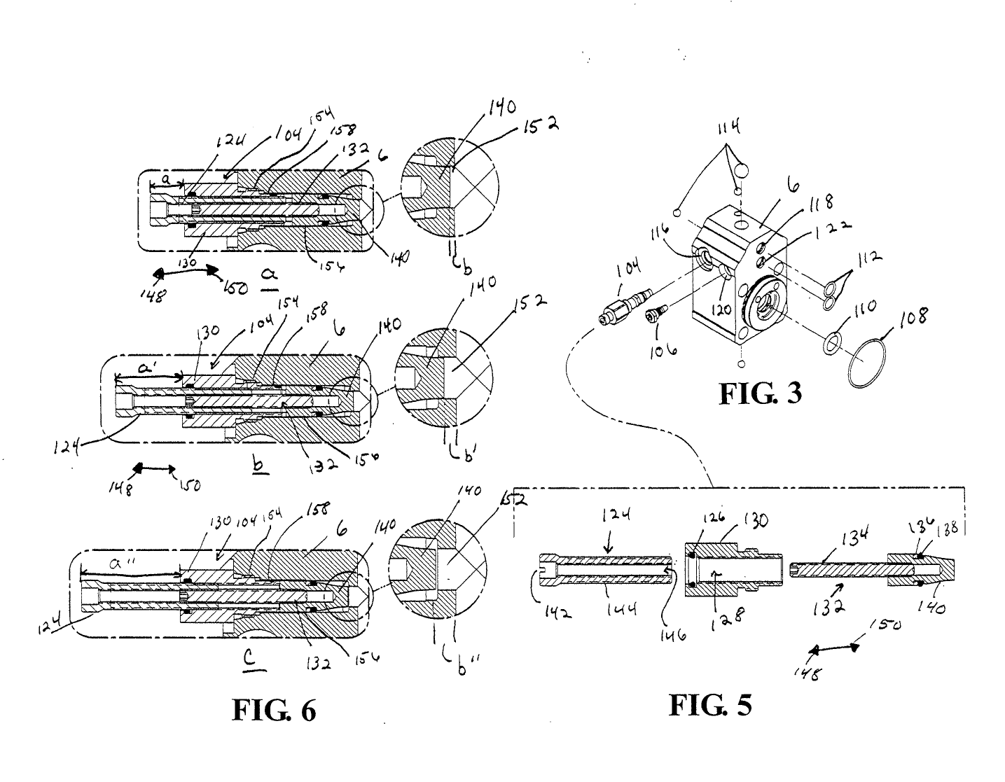

An exploded view of cap 6 with cushion control needle assembly 104 and accumulator needle 106 is shown in FIG. 3. Also shown in this view are seals 108, 110 and 112, along with ball plugs 114. This view shows how cushion control needle 104 is configured to extend into opening 116 to control fluid that exits through port 118. Accumulator needle 106 extends through opening 120 to control fluid that passes through port 122.

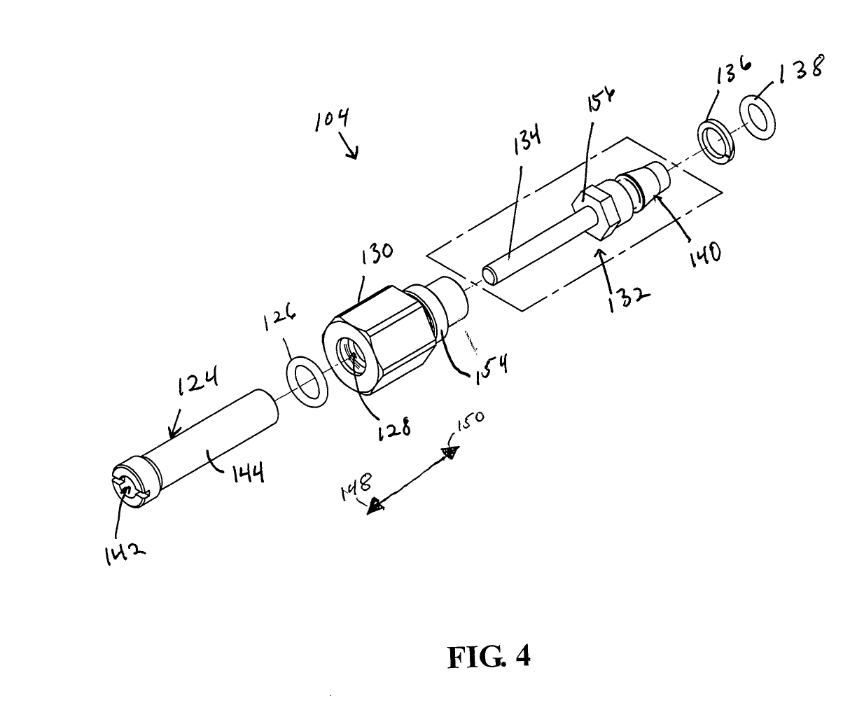

An exploded view of cushion control needle 104 is shown in FIG. 4. This view shows needle 104 as being an assembly comprising a cushion control differential screw 124 with slotted head 142 extends through a friction ring 126 and opening 128 of retainer 130. Surface 144 is threaded and configured to extend into bore 128 of retainer 130. Control needle 132 includes a stem 134 that also extends through bore 128 on the opposite side of retainer 130 and is engageable with the inside of cushion control screw 124. Lastly, a backup ring 136 and seal 138 fasten to needle head 140 of control needle 132.

A cross-sectional exploded view of needle 104 is shown in FIG. 5. This view further shows the internal configurations of needle 104. As shown, head 142 of cushion control screw 124 illustratively includes a slot or other configuration that is engageable with a screw driver or similar tool to rotate screw 124. Bore 146 of screw 124 is threaded with complimentary threads to those formed on stem 134 so that rotating screw 124 will extend or retract control needle 132 in either direction 148 or 150. It is appreciated that the threads of surface 144 do not match the threads on stem 134. This view also shows how o-ring friction 126 and 138 fit onto needle 104, and backup ring 136 seated on needle head 140.

Side cross-sectional and detailed views of needle 104 extended into cap 6 are shown in FIGS. 6a-c. The view shown in FIG. 6a includes needle 104 positioned in a fully closed position. As specifically demonstrated in the accompanying detailed view, needle head 140 completely blocks opening 152 in cap 6. This is accomplished by rotating screw 124 so it moves in direction 150. This causes control needle 132 to also move in direction 150 causing needle head 140 to block opening 152. In an illustrative embodiment, retainer 130 includes a threaded surface 154 (see, also, FIG. 4) so it can securely fasten in opening 116 of cap 6 (see FIG. 3). In other words, as screw 124 rotates it does so relative to retainer 130 which does not move. In addition, a stationary hex nut 156 attached to control needle 132 (see also FIG. 4) corresponds to a hexagonal-shaped cavity 158 so control needle 132 does not rotate as it moves in directions 148 and 150. It is appreciated that triangle, square or other non-rotating shape could be used.

The view shown in FIG. 6b is similar to that in 6a except that screw 124 has been rotated to move it in direction 148 which likewise retracts control needle 132 which partially opens opening 152 by retracting needle head 140. What is also distinguishable between FIGS. 6a and b is that the comparable distance screw 124 is moved from retainer 130, as indicated by distance a and a′ in FIGS. 6a and b, and is relatively much greater than the distance needle head 140 moves, as indicated by distances b and b′. In other words, these views show that by rotating screw 124 a relatively substantial amount, there is a correspondingly small movement of the needle head 140. A relatively large rotational movement of screw 124 results in relatively small linear movement of needle head 140. This results in an ability to make very fine adjustments of the needle head 140 without having to make correspondingly minute turns of screw 124. This makes it easier for the operator to make fine tuning adjustments.

The view in FIG. 6c shows how rotating screw 124, to move it even further in direction 148, creates another correspondingly small movement of head 140 relative to opening 152, as indicated by distance b″. This view shows how air can escape between opening 152 and head 140, but in order to create that opening, screw 124 was moved in direction 148 a substantial amount, as evidenced by comparing distances a and a″ in FIGS. 6a and 6c, respectively.

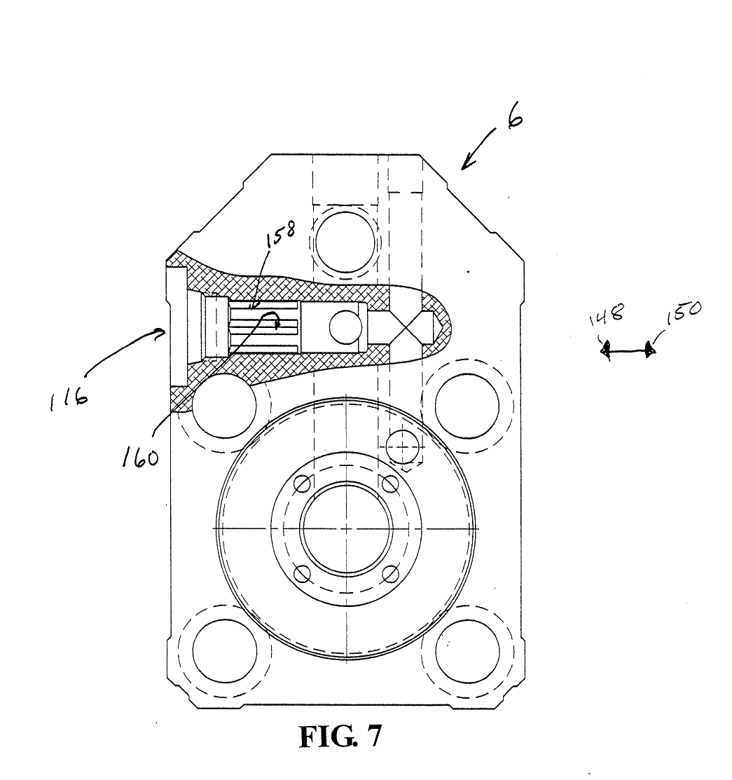

A partial cutaway view of cap 6 is shown in FIG. 7. This view shows the illustrative configuration of bore 158 adjacent opening 116. This view also demonstrates how portions of bore 158 are not round such as section 160 which has a periphery that is complimentarily-shaped to hex nut 156 on control needle 132 (see, also, FIG. 4). As previously discussed, this prevents needle 132 from rotating as it moves linearly in directions 148 or 150. It is appreciated that both hex nut 156 and the corresponding periphery of section 160 can have other profiles, as long as they prevent the needle 132 from rotating.

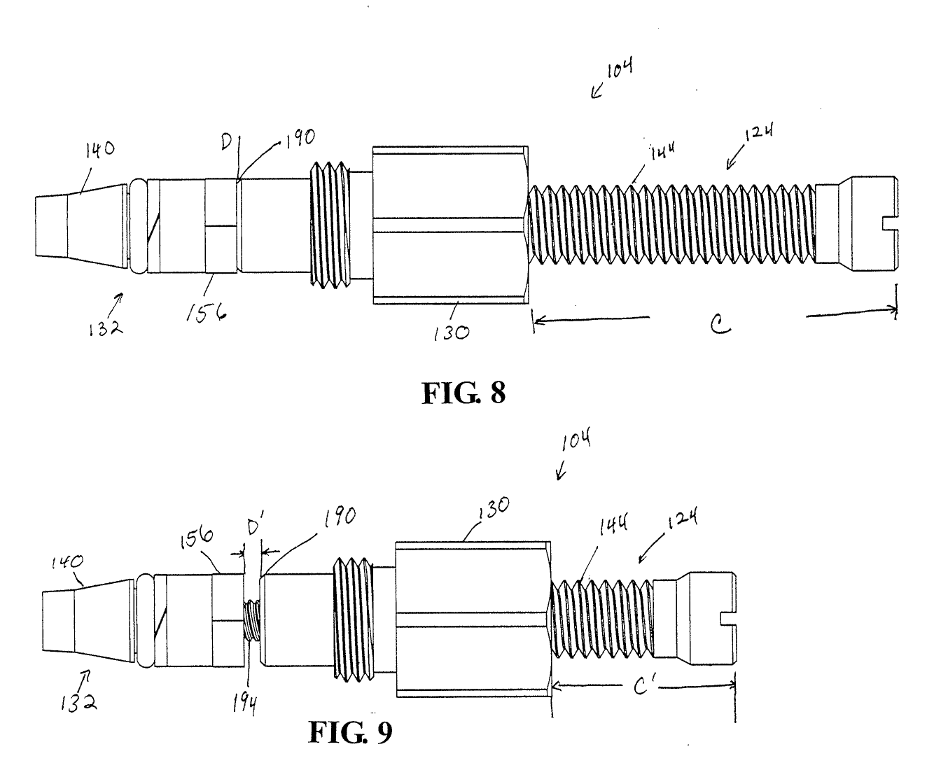

Side views of needle 104 are shown in FIGS. 8 and 9. These views demonstrate how rotating screw 124 a significant amount translates into minimal linear movement of needle head 140. Contrasting the distance between the end of screw 124 and retainer 130, as indicated by distances C of FIG. 8 and C′ of FIG. 9, helps illustrate the magnitude of change. Moving screw 124 a relatively large distance from C to C′ results in a relatively small linear movement of needle head 140 from the end of retainer 130, surface 190. The initial distance D is effectively zero. As shown, the distance between C and C′ is substantially greater than the distance between D and D′. This means that very precise movements of needle head 140 can be made. This is achieved by employing different thread leads on each component. For example, the threaded surface 144 of screw 124 could have a thread lead of about 0.0357, while the threaded surface 194 of stem 134 has an illustrative lead of about 0.0313. This translates into about 34.23 turns of screw 124 to move stem 134 a linear distance of about 0.153. It is appreciated, however, that these leads are illustrative. It is the difference in the leads that achieve the desired result.

The relative pitch difference in the two screw threads determines the linear motion of the needle adjustment as it relates to the angular motion or number of turns of the adjusting screw.

For example, the larger diameter slotted adjustment screw that is rotated to move the needle into or out of the orifice is a 28 pitch screw, a ¼ diameter may be used because it is a common screw size and is easily and inexpensively produced. A common 10-32 set screw may be used as the second pitch thread because it is easily obtained and is also a low cost part. The diameter of the #10-32 set screw is smaller than the ¼-28 slotted adjustment screw so it easily accepts the #10 set screw within the needle assembly.

The formula for differential screws may be: (1/(Pitch1))−(1/(Pitch2))=inches per turn. The reciprocal of this number is the equivalent pitch. In this case 1/28−1/32=0.004464 (inch/turn) equals 1/.004464 or 224 turns per inch. Note that if this number is negative, a clockwise rotation of adjusting screw will pull the needle out of the orifice, just opposite of the direction that is customarily seen when turning a screw clockwise. If the number is positive, turning the screw clockwise will push the needle into the orifice as is customarily expected.

The travel of the needle may be determined by taking the equivalent pitch multiplied by the number of revolutions to turn. In this case (1/224*revolutions)=travel. However if desired travel is known, in this case 0.153 inches of needle travel, the number of turns may be determined. This equates to, Equivalent Pitch multiplied by the desired travel. The formula being (0.153*224)=34.2 turns.

To determine how long each of the two screws may be and their individual travels, the number of turns, in this case 34.2 and for the first screw (¼-28) is multiplied by the 1/pitch of the first screw, in this case 34.2/28=1.224 inches. For the second screw (10-32) with a pitch of 32, travel will be equal; (34.2*1/32)=1.071 inches. When used as described in this disclosure each screw will travel as shown in the above description. The difference between the two travels is the actual needle travel adjusting the flow out of the orifice.

The charts below describe additional thread pitches and how they may affect travel and number of turns. Please notice that the second chart shows that a 5/16-28 and #8-32 combination gives an equivalent screw pitch as the ¼-28 and 10-32 combinations shown in the upper chart.

| ¼ dia | | #10 dia | | | | | | | |
|---|---|---|---|---|---|---|---|---|---|
| | Inches | | Inches | Difference | | | | | |
| | per | | per | between | | | | Thread | Thread |
| | Turn, | | Turn, | Screw 1 | Equivalent | | Number of | Length | Length |
| Screw | Screw | Screw | Screw | and Screw | Screw | Travel | Turns to | Travel for | Travel for |
| Pitch 1 | 1 | Pitch 2 | 2 | 2 | Pitch | Length | Travel | Screw 1 | Screw 2 |
| 28 | 0.0357 | 32 | 0.0313 | 0.0045 | 224.0 | 0.153 | 34.272 | 1.224 | 1.071 |
| 20 | 0.0500 | 32 | 0.0313 | 0.0188 | 53.3 | 0.153 | 8.16 | 0.408 | 0.255 |
| 20 | 0.0500 | 24 | 0.0417 | 0.0083 | 120.0 | 0.153 | 18.36 | 0.918 | 0.765 |
| 28 | 0.0357 | 24 | 0.0417 | −0.0060 | −168.0 | 0.153 | −25.704 | −0.918 | −1.071 |
| 40 | 0.0250 | 32 | 0.0313 | −0.0063 | −160.0 | 0.153 | −24.48 | −0.612 | −0.765 |

| 5/16 dia | | #8 dia | | | | | | | |
|---|---|---|---|---|---|---|---|---|---|
| | Inches | | Inches | Difference | | | | | |
| | per | | per | between | | | | Thread | Thread |
| | Turn, | | Turn, | Screw 1 | Equivalent | | Number of | Length | Length |
| Screw | Screw | Screw | Screw | and Screw | Screw | Travel | Turns to | Travel for | Travel for |
| Pitch 1 | 1 | Pitch 2 | 2 | 2 | Pitch | Length | Travel | Screw 1 | Screw 2 |
| 40 | 0.0250 | 32 | 0.0313 | −0.0063 | −160.0 | 0.153 | −24.48 | −0.612 | −0.765 |
| 40 | 0.0250 | 36 | 0.0278 | −0.0028 | −360.0 | 0.153 | −55.08 | −1.377 | −1.53 |
| 28 | 0.0357 | 32 | 0.0313 | 0.0045 | 224.0 | 0.093 | 20.832 | 0.744 | 0.651 |

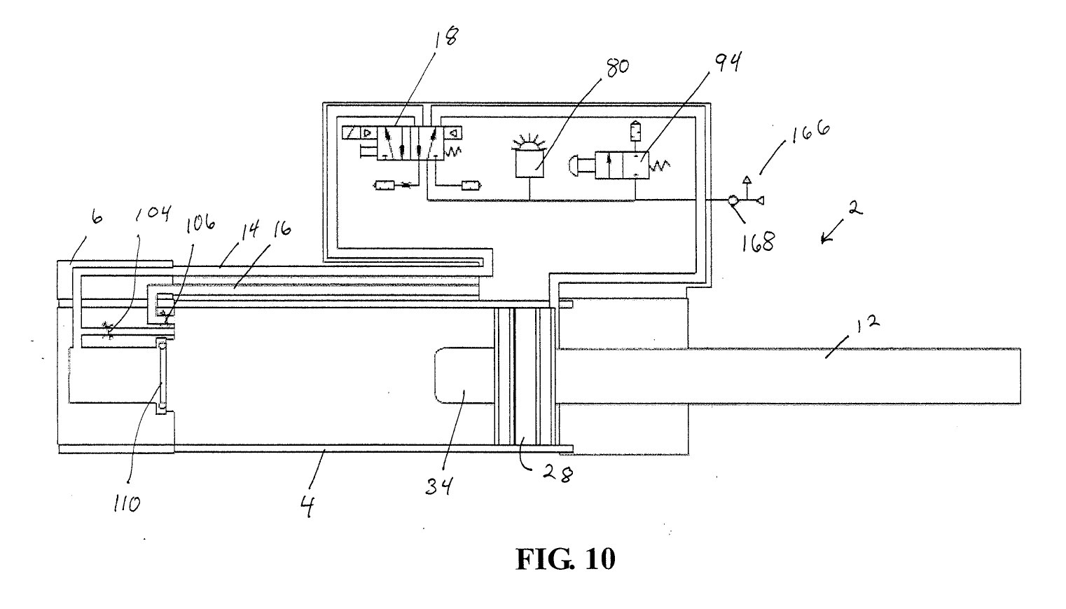

FIGS. 10 through 20 are diagrammatic side views of slide assembly 2 demonstrating how piston rod 12 and piston 28 move and employ pneumatic air pressure to serve as a cushion. In the view of FIG. 10, cushion stud 34, seal 110, cushion needle 104, accumulator tube needle 106, pressure accumulator tube 16, fluid distribution assembly 18, pressure indicator 80, bleed off valve 94, fluid supply port 166, and check valve 168 are all shown. Here pressure is supplied to neither side of the piston.

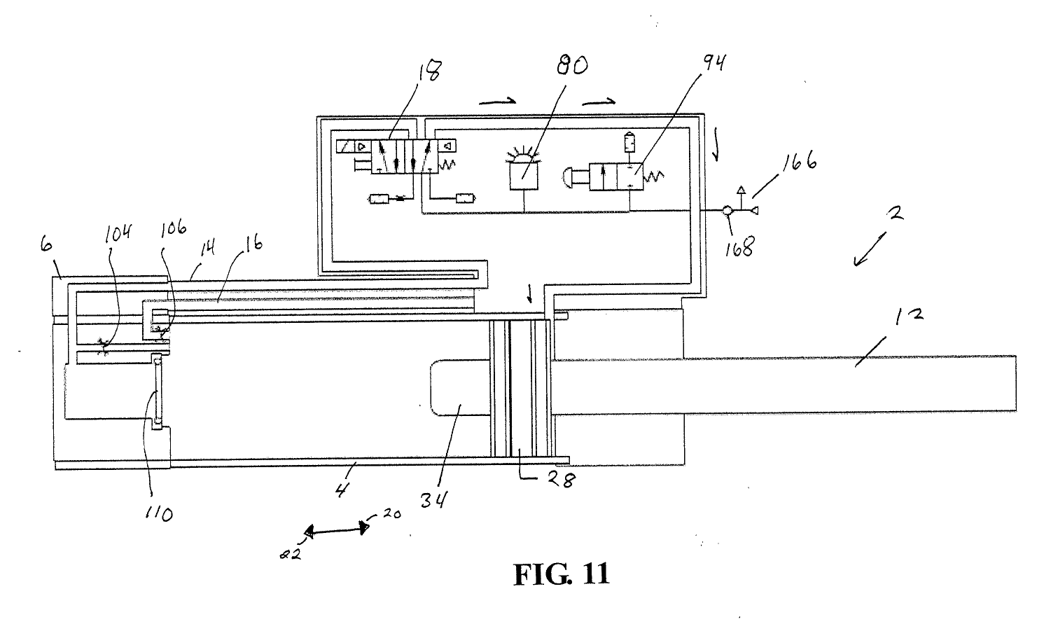

The view in FIG. 11 shows fluid being supplied to the rod side of piston 28 to move the same in direction 22. Exhaust air will flow from the cap 6 side of piston 28. Check valve 168 is open to allow pressure into the system but not back out to the pneumatic supply. When this occurs the pressure indicator 80 is activated to indicate air flow entering the system.

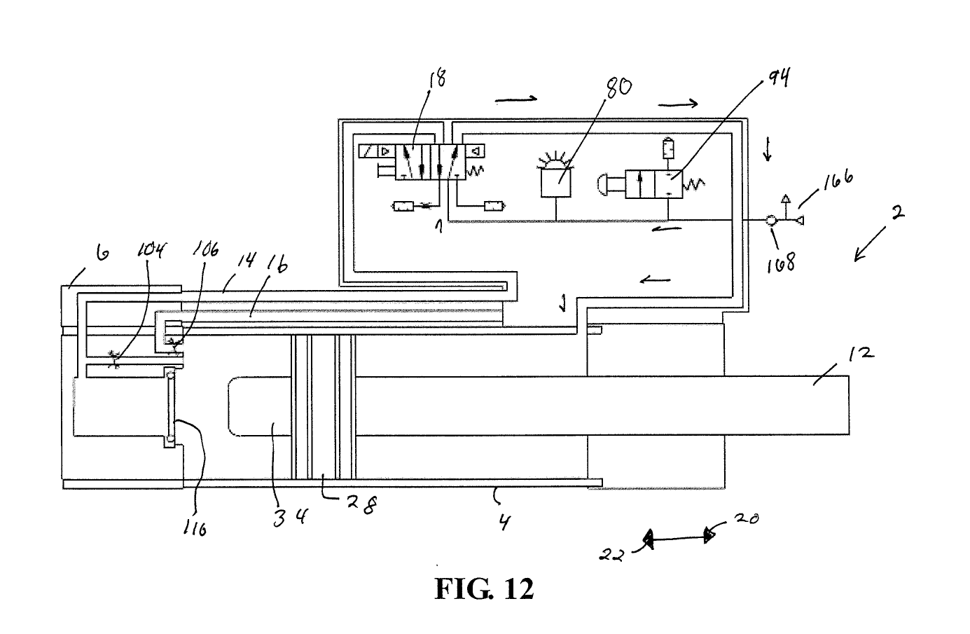

The view in FIG. 12 shows fluid continuing to enter the rod side of cylinder 4 which continues to move piston 28 and piston rod 12 in direction 22. The position shown in this view is about the mid-stroke of piston 28.

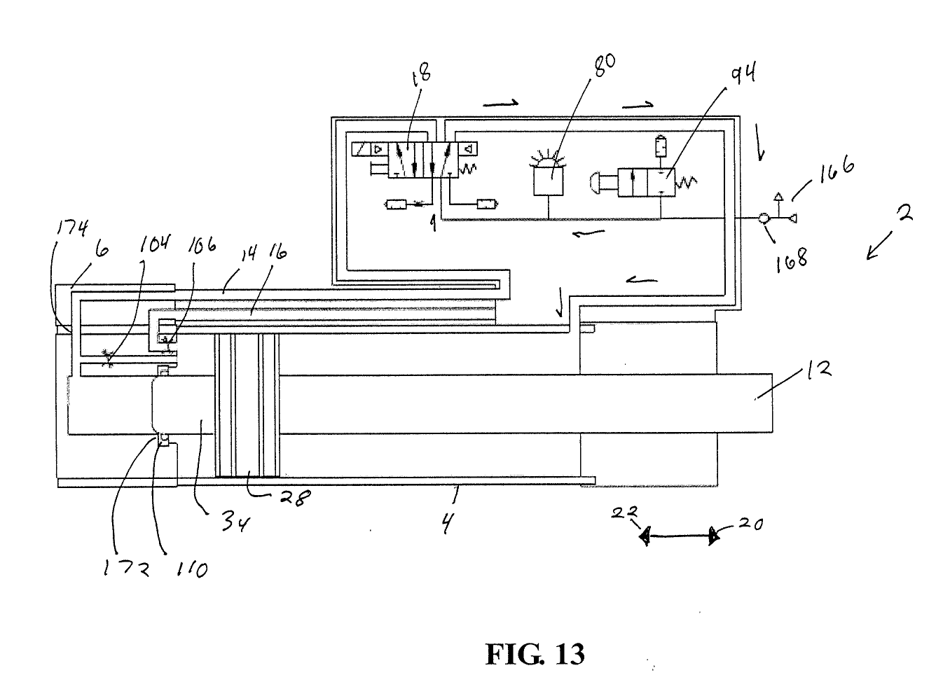

The view shown in FIG. 13 includes piston 28 moving far enough in direction 22 to cause cushion stud 34 to enter cushion cavity 170. This causes stud 34 to push seal 110 towards the back of seal gland 172. This blocks free flow of exhaust out of the system through conduit 174.

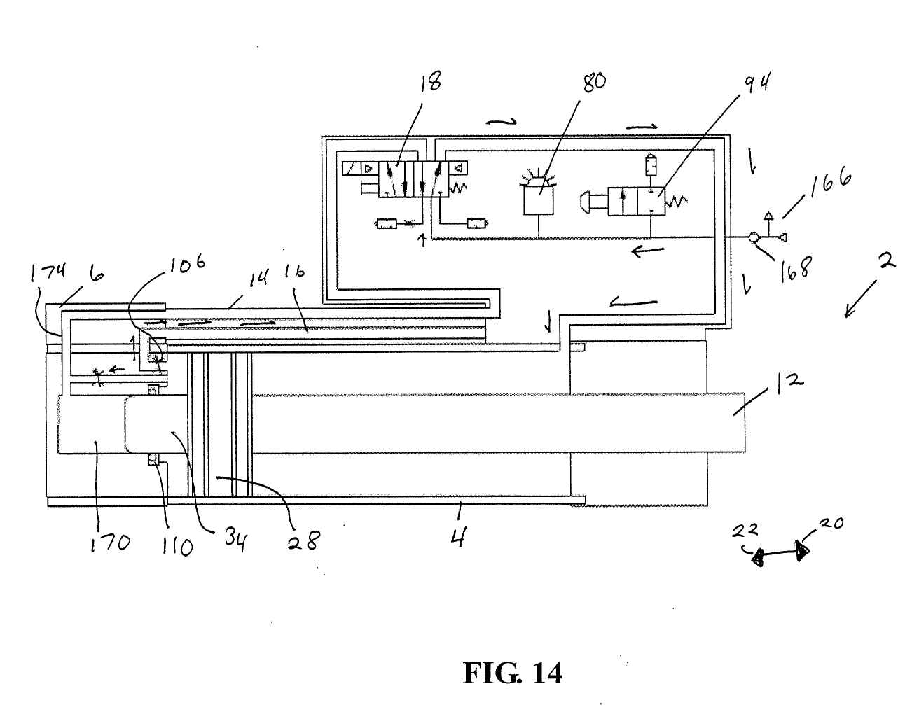

The view of FIG. 14 shows cushion stud 34 blocking normal exhaust flow so that air must exhaust through cushion control needle 104. This slows the motion of piston 28 and piston rod 12. In addition, pressure is increased in the cylinder and in accumulator tube 16 due to recompression of the pneumatic pressure. This “back pressure” provides the resistance against piston 28, thereby slowing it down.

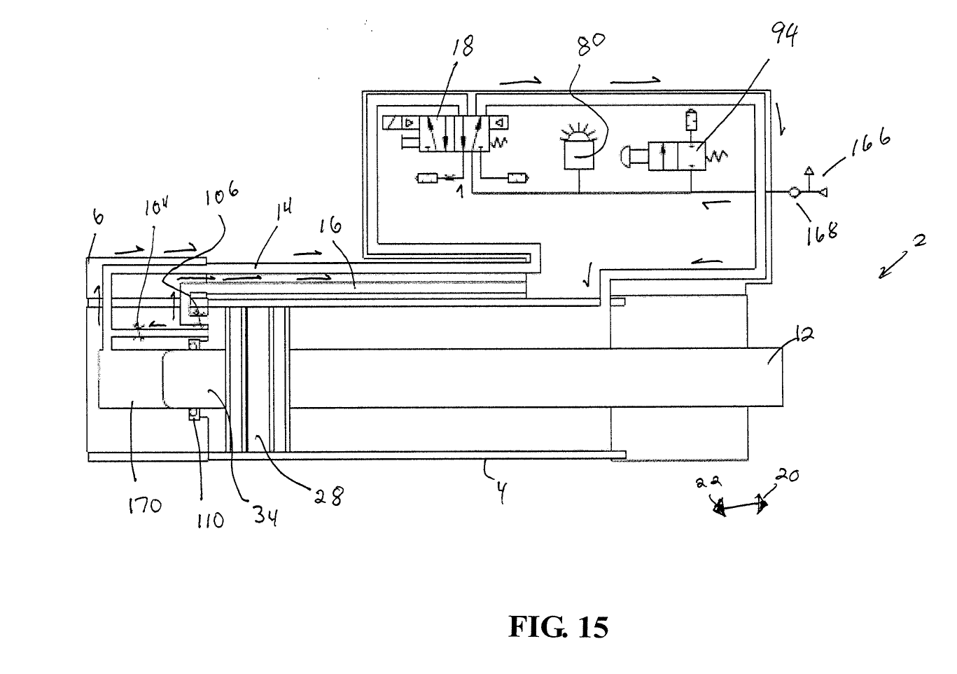

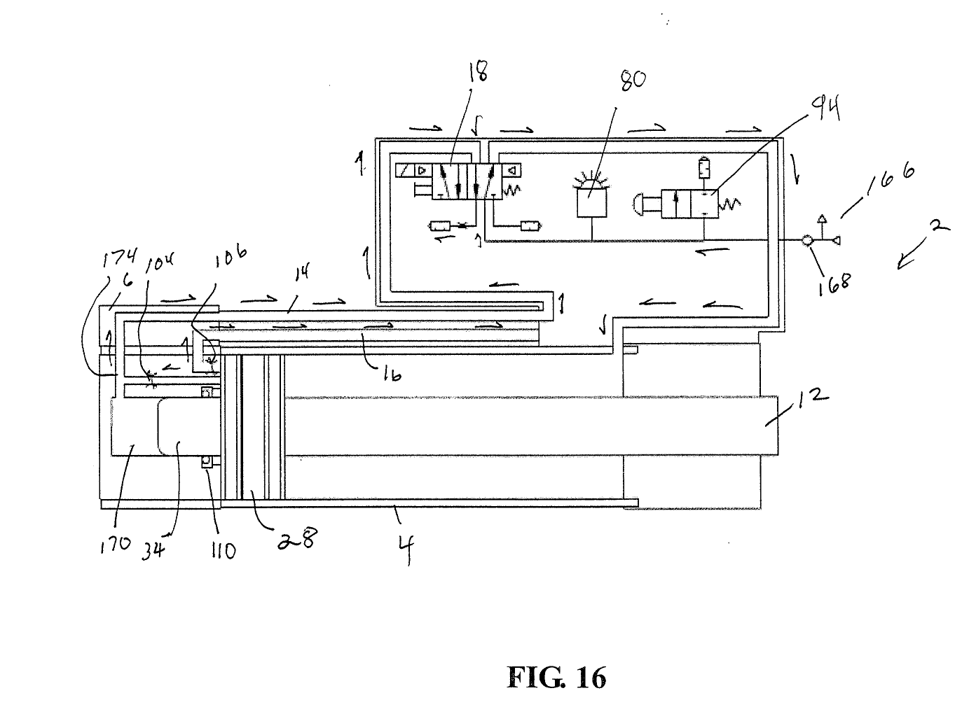

The view in FIG. 15 shows how back pressure exhausts around needle 104 and fluid distribution assembly 18. Back pressure also “charges” accumulator tube 15 through accumulator needle 106. With the back pressure continuing to exhaust as shown in FIG. 16, accumulator tube 16 is continuing to charge as piston 28 ends its stroke.

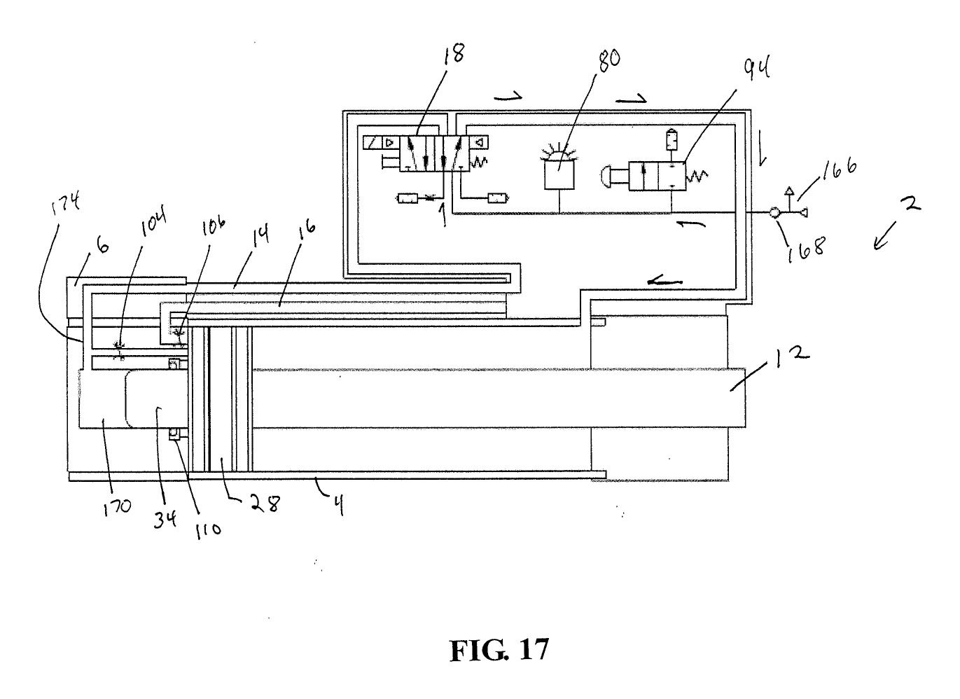

The view shown in FIG. 17 includes piston 28 completing its stroke with the air cushion caused by the back pressure stopping the load. That back pressure then exhausts out of cylinder 4 through needle 104. It is appreciated that accumulator tube 16 provides additional pneumatic volume to increase the control of needle 104.

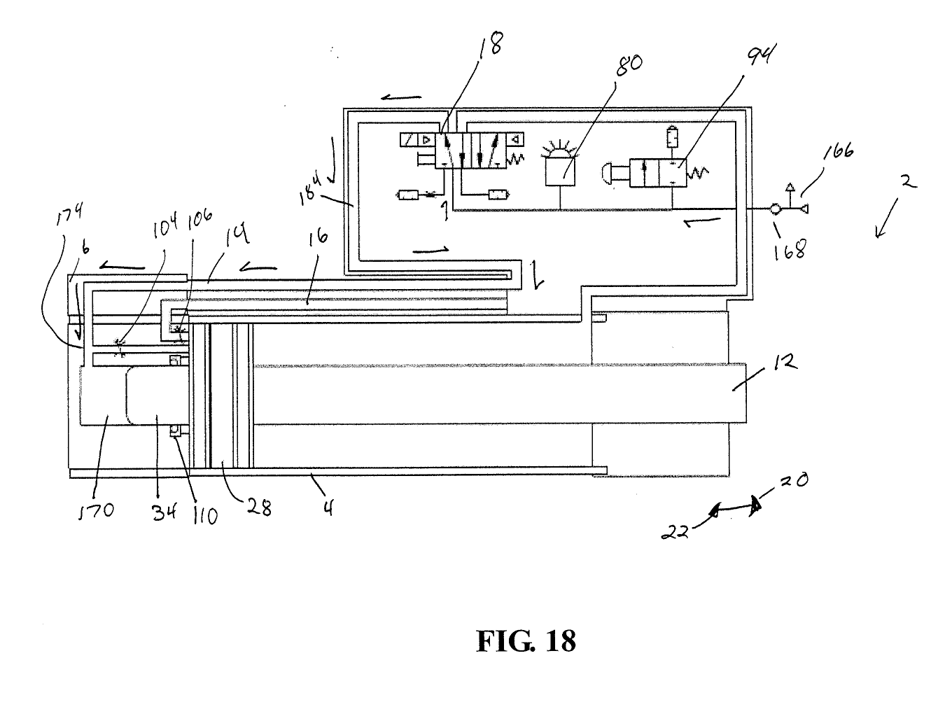

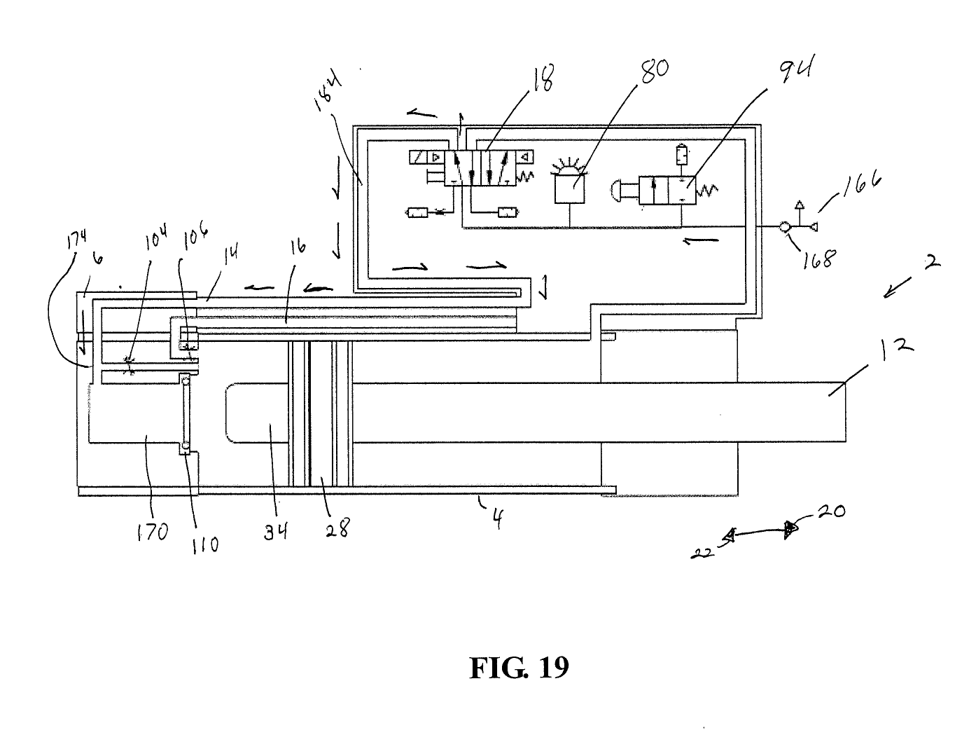

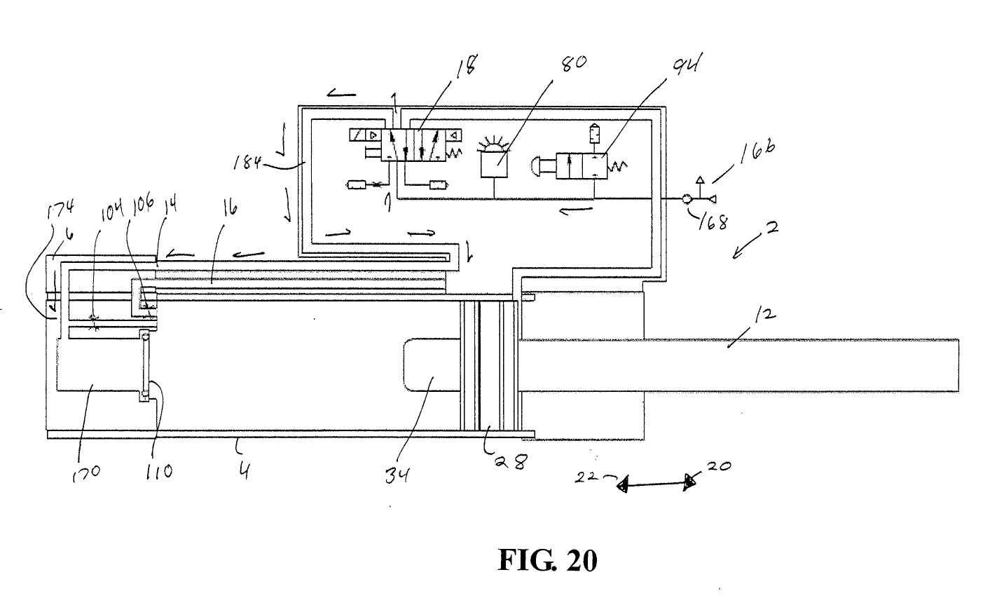

The views in FIGS. 18 and 19 show the reverse process where fluid enters from supply 166 to fluid distribution assembly 18, then through passage 184 and 174 to enter the cap 6 side of cylinder 4 to move piston 28 and piston rod 12 in direction 20. While this is happening, fluid is also charging accumulator tube at 16. Lastly, as shown in FIG. 20, while piston 28 ends its stroke in direction 20, accumulator tube 16 becomes recharged and ready for the next cycle.

Corresponding reference characters indicate corresponding parts throughout the several views. Although the present disclosure has been described with reference to particular means, materials and embodiments, from the foregoing description, one skilled in the art can easily ascertain the essential characteristics of the invention and various changes and modifications may be made to adapt the various uses and characteristics without departing from the spirit and scope of the invention.

What is claimed:

1. A fluid cylinder actuator assembly, comprising:
a cylinder tube;
a cap located at a first end of the cylinder tube;
a head located at a second end of the cylinder tube opposite the first end;
a rod that extends through the cylinder tube and the head;
a piston coupled to the rod inside the cylinder tube and separating the cylinder tube into extend and retract sides;
wherein the rod is configured to move between extend and retract positions;
a fluid transfer tube that extends between the cap and a manifold assembly and is configured to distribute pneumatic fluid to the extend side of the cylinder tube;
an accumulator chamber also positioned between the cap and the manifold assembly and is in fluid communication with the extend side of the cylinder;
a fluid distribution assembly attached to the cylinder actuator assembly and configured to distribute fluid between retract and extend sides of the cylinder tube;
a cushion stud that extends from the piston opposite from the rod and is configured to selectively extend into a receptacle in the cap;
a cushion control needle assembly configured to extend into an opening in the cap to control fluid that exits from the retract side of the cylinder tube.

2. The fluid cylinder actuator assembly of claim 1, wherein the cushion control needle assembly further comprises a threaded cushion control differential screw that selectively screws into a retainer having corresponding threads; and a control needle that includes a stem that is selectively extendable through a bore formed in the retainer; wherein the stem of the control needle is engageable with a threaded bore formed inside the cushion control differential screw.

3. The fluid cylinder actuator assembly of claim 2, wherein the threaded bore of the threaded cushion control differential screw is engageable with complimentary threads formed on the stem so that rotating the threaded cushion control differential screw extends or retracts the control needle back and forth.

4. The fluid cylinder actuator assembly of claim 3, wherein the threaded surface of the threaded cushion control differential screw is different than the threads on the stem.

5. The fluid cylinder actuator assembly of claim 4, wherein the opening in the cap that receives the cushion control needle assembly forms a bore having surfaces that are not round.

6. The fluid cylinder actuator assembly of claim 5, wherein the bore having surfaces that are not round has surfaces that are hex shape and are complimentary to a nut located on the control needle to prevent the control needle from rotating as it moves back and forth in the bore of the cap to limit the amount of air that can escape the cap.

7. The fluid cylinder actuator assembly of claim 5, wherein the bore has at least one non-curved shape that is complimentary to a non-curved shape located on the control needle to prevent the control needle from rotating as it moves back and forth in the bore of the cap to limit the amount of air that can escape the cap.

8. The fluid cylinder actuator assembly of claim 1, wherein the head includes a flange that is attachable to a blow mold machine.

9. The fluid cylinder actuator assembly of claim 1, wherein the rod further comprises an eyelet at its end thereof opposite its coupling to the piston.

10. The fluid cylinder actuator assembly of claim 1, wherein an accumulator needle extends through a second opening in the cap to control fluid that passes through a second passage in the cap that is in fluid communication with the accumulator chamber.

11. The fluid cylinder actuator assembly of claim 1, further comprising a muffler and an orifice plug assembly that attach to the manifold.

12. The fluid cylinder actuator assembly of claim 1, further comprising a visual pressure indicator that couples to the manifold.

13. The fluid cylinder actuator assembly of claim 1, wherein the cushion control differential screw is configured to rotate which translates minimal linear movement of the control needle.

14. The fluid cylinder actuator assembly of claim 1, wherein about 34 turns of the cushion control differential screw is configured to move the control needle a linear distance of about 0.153 inches.

15. A fluid cylinder actuator assembly, comprising:
a cylinder tube;
a cap located at a first end of the cylinder tube;
a head located at a second end of the cylinder tube opposite the first end;
a rod that extends through the cylinder tube and the head;
a piston coupled to the rod inside the cylinder tube separating the cylinder tube into extend and retract sides;
wherein the rod is configured to move between extend and retract positions;
a cushion control needle assembly configured to extend into an opening in the cap to control fluid that exits from the retract side of the cylinder tube;
wherein the cushion control needle assembly further comprises a threaded cushion control differential screw that selectively screws into a retainer having corresponding threads; a control needle that includes a stem that is selectively extendable through a bore in the retainer opposite of the cushion control differential screw; wherein the stem of the control needle is also engageable with a threaded bore inside the cushion control differential screw; wherein the threads of the threaded bore are complimentary to the threads formed on the stem so that rotating the threaded cushion control differential screw will extend or retract the control needle back and forth; and wherein the threaded surface of the threaded cushion control differential screw is different than the threads on the stem.

16. The fluid cylinder actuator assembly of claim 15, wherein the opening in the cap that receives the cushion control needle assembly includes a bore having surfaces that are not round.

17. The fluid cylinder actuator assembly of claim 16, wherein the bore having surfaces that are not round has a hex shape surface complimentary to a nut located on the control needle to prevent the control needle from rotating as it moves back and forth in the bore of the cap to limit the amount of air that can escape the cap.

18. The fluid cylinder actuator assembly of claim 5, wherein the bore has at least one non-curved shape that is complimentary to a non-curved shape located on the control needle to prevent the control needle from rotating as it moves back and forth in the bore of the cap to limit the amount of air that can escape the cap.

19. The fluid cylinder actuator assembly of claim 16, wherein the head includes a flange that is attachable to a blow mold machine.

20. The fluid cylinder actuator assembly of claim 16, wherein the rod further comprises an eyelet at its end thereof opposite its coupling to the piston.

21. The fluid cylinder actuator assembly of claim 16, further comprising an accumulator needle that extends through a second opening in the cap to control fluid that passes through a second passage in the cap that is in fluid communication with an accumulator chamber.

22. The fluid cylinder actuator assembly of claim 16, further comprising a muffler and an orifice plug assembly that attach to a manifold.

23. The fluid cylinder actuator assembly of claim 22, further comprising a visual pressure indicator that couples to the manifold.

24. The fluid cylinder actuator assembly of claim 16, wherein the cushion control differential screw is configured to rotate which translates minimal linear movement of the control needle.

25. The fluid cylinder actuator assembly of claim 16, wherein about 34 turns of the cushion control differential screw is configured to move the control needle a linear distance of about 0.153 inches.

26. A fluid cylinder actuator assembly, comprising:
a cylinder tube;
a cushion control needle assembly that is configured to extend into the fluid cylinder actuator assembly to control fluid that exits the cylinder tube;
wherein the cushion control needle assembly further comprises a threaded cushion control differential screw that selectively screws into a retainer having corresponding threads; a control needle that includes a stem selectively extendable through a bore in the retainer opposite of the cushion control differential screw; wherein the stem of the control needle is engageable with a threaded bore inside the cushion control differential screw that is complimentary to the threads formed on the stem so that rotating the threaded cushion control differential screw will selectively extend or retract the control needle back and forth; and wherein threads of the threaded cushion control differential screw is different than the threads in its threaded bore.
